(19) United States
(12) Patent Application Publication
(10) Pub. No.: US 2024/0029145 A1
(43) Pub. Date: Jan. 25, 2024

(54) MICRO FULFILLMENT CENTER WITH G2P STORAGE WITH FRESH ORDER-LINE BATCH PICK FROM STORE FLOOR AND METHOD OF OPERATING SAME

(71) Applicant: Walmart Apollo, LLC, Bentonville, AR (US)

(72) Inventor: John G. Lert, JR., Wakefield, MA (US)

(21) Appl. No.: 18/221,071

(22) Filed: Jul. 12, 2023

Related U.S. Application Data
(60) Provisional application No. 63/388,487, filed on Jul. 12, 2022.

(51) Int. Cl. G06Q 30/0601; G06Q 10/087; B65G 1/137

(52) U.S. Cl. CPC G06Q 30/0635; G06Q 10/087; B65G 1/137

(57) ABSTRACT

A store includes a self-service area where shoppers select goods from shelves, and an automated goods-to-person (G2P) area where stored goods are transported by mobile robots to a picking workstation or automated fulfillment of online orders. In one example, fresh order-line goods may be batch picked from the self-service area and transferred to the G2P area for automated fulfillment of orders for the fresh order-line goods. Fresh order-line goods may for example include meats, produce and other fresh foods packaged in the store deli or butcher which require some secondary operation before they can picked into a finished order.

### CROSS-REFERENCE TO RELATED APPLICATION

This application claims the benefit of U.S. Provisional Application No. 63/388,487 filed on Jul. 12, 2022, which is incorporated herein by reference in its entirety.

### BACKGROUND

The most intractable problem facing supermarket operators today is finding a way to satisfy the growing market demand for online grocery service profitably. Their prices are based on the self-service retail model in which customers provide free labor to the retailer by picking their own orders, but the e-commerce model requires the retailer to pick the order and transfer it to the customer. Further, they are constrained in raising prices to cover these additional costs by fierce competitive pressure in this highly price-driven trade category.

Fulfilling online orders from their existing self-service stores has many compelling advantages over building separate facilities for this purpose, but it also poses several challenging problems, the primary one being labor costs associated with picking and handling orders. Retailers universally use a route-picking version of picker-to-goods (“P2G”) picking, and additional labor costs are incurred in storing, retrieving, and dispensing completed orders either to a customer picking up from the store or to a delivery driver. These labor costs are so high that it is virtually impossible today for retailers to realize profits from their online service with this model.

A second major problem with in-store picking is that self-service stores are fairly chaotic environments, making it very difficult for retailers to maintain accurate information about the on-hand inventory of all of the 40,000 or so products typically sold in each of their stores, so out-of-stocks are not uncommon. Self-service stores can operate successfully with relatively inaccurate inventory data, because a customer who discovers that a product is out of stock makes his/her own decision whether to buy a substitute product or to forego the purchase at that moment. However, with online ordering, that decision must be made by the retailer, and substitutions and out-of-stocks are known to be the greatest source of customer dissatisfaction with online grocery. The third key problem with in-store fulfillment is that the large multi-order carts clog up the aisles and degrade the experience for the customers who are picking their own orders (and are therefore contributing higher profit margins to the retailer than the online orders the pickers are picking). There is thus a significant risk of customers becoming so annoyed that they switch to shopping at a different retailer's store.

To overcome these challenges of in-store fulfillment, retailers are now experimenting with automation technology deployed inside or attached to their stores that performs a goods-to-picker (“G2P”) order-picking process in which products to be picked are typically stored within the system in totes or other containers, and product totes containing ordered SKUs are conveyed through a picking workstations where stationary human (or robotic) pickers transfer the ordered eaches from the product totes into order containers. This technology solution addresses all three of the major problems associated with P2G picking described above. A stationary G2P system can pick many more eaches per hour than the traveling P2G picker, so the labor costs of picking can be dramatically reduced. (Once robotic pickers are used for this task, labor cost will be reduced even further.) In addition, the automation system can store, retrieve, and dispense the completed orders, thereby reducing or eliminating labor costs associated with these additional handling tasks. Moreover, the information about on-hand inventory is much higher when the inventory is stored in an automated G2P system than when it is sitting on the shelf in the store, so substitutions and out-of-stocks are greatly reduced and customer satisfaction is thereby increased. Finally, picking in an automated G2P system removes the pickers from the store floor, thereby eliminating that source of annoyance to self-service customers.

However, retailers must solve two closely related problems associated with installing an automated G2P system in a store. The first is physical space, because a G2P system requires its own cache of inventory, separate from the self-service store, to be used as the picking stock in fulfilling online orders. Moreover, offering online customers the full range of products found in the store has been shown to be an important factor in getting them to adopt online grocery, so limiting the assortment available to online customers to include only what can fit into these small systems is a suboptimal solution competitively.

### FIGURES

FIG. 1 is a block diagram of a store according to embodiments of the present technology.

FIG. 2 is a flowchart showing store-wide replenishment and depletion of inventory according to embodiments of the present technology.

FIG. 3 is a flowchart showing a method of a store floor-based batch pick of fresh order-lines.

FIG. 4 is a flowchart showing a method utilizing a store floor-based batch pick of fresh order-lines followed with automated storage and dispense of completed picked orders including the fresh order-lines.

### DETAILED DESCRIPTION

Embodiments of the present technology will now be described with reference to the figures, which in general relate to a micro-fulfillment center and more specifically to systems and methods of operating of a micro-fulfillment center. In one embodiment, the present technology relates to a store including a self-service area where shoppers in the store can fulfill their orders by self-selecting goods off the shelves. The store further includes an automated goods-to-person (G2P) area, separate from the self-service area, comprising an automated storage and retrieval system configured with storage areas to store goods and one or more picking stations where orders for goods are fulfilled. In particular, product totes or containers from the storage area may be transferred to a picking workstation by mobile robots. At the picking workstation, goods from one or more product totes may be transferred to an order tote including goods to fulfill the order.

In embodiments, goods from the self-service area may be picked to replenish goods stored in the G2P area. One such group of goods includes fresh order-line goods, which include for example meats, produce and other fresh foods packaged in the store deli or butcher which require some secondary operation before they are transferred to the G2P area and picked into a finished order. Examples of such secondary operations include bagging, weighing, or scanning a bar code on the packaging to identify product information on the fresh order-line goods.

It is understood that the present embodiments may be embodied in many different forms and should not be construed as being limited to the embodiments set forth herein. Rather, these embodiments are provided so that this disclosure will be thorough and complete and will fully convey the invention to those skilled in the art. Indeed, the embodiments are intended to cover alternatives, modifications and equivalents of these embodiments, which are included within the scope and spirit of the invention as defined by the appended claims. Furthermore, in the following detailed description, specific details are set forth in order to provide an understanding of the present embodiments.

The terms “top” and “bottom,” “upper” and “lower” and “vertical” and “horizontal” as may be used herein are by way of example and illustrative purposes only and are not meant to limit the description of the embodiments inasmuch as the referenced item can be exchanged in position and orientation. Also, as used herein, the terms “substantially” and/or “about” mean that the specified dimension or parameter may be varied within an acceptable manufacturing tolerance for a given application. In one non-limiting embodiment, the acceptable manufacturing tolerance is ±2.5%.

The store formats, operating systems and methods disclosed may be used in conjunction with robotic picking system(s) and robotics, for example, as disclosed in U.S. Pat. No. 11,142,398 having issue date Oct. 12, 2021 and entitled “Order Fulfillment System” which is incorporated by reference herein in its entirety. Similarly, the store formats, operating systems and methods disclosed may be used in conjunction with a robotic picking system(s) and robotics that are deployed in conjunction with retail store formats, for example, as disclosed in U.S. Pat. No. 11,142,402 having issue date Oct. 12, 2021 and entitled “Automated-Service Retail System and Method” which is incorporated by reference herein in its entirety. Further, the store formats, operating systems and methods disclosed herein may be used in conjunction with different elements of full or partially automated supply chain systems, for example, as disclosed in the following: U.S. Patent Publication Number US2021/0261335 A1 having publication date Aug. 26, 2021 and entitled “Automated Retail Supply Chain and Inventory Management System”; U.S. Pat. No. 10,919,701 having issue date Feb. 16, 2021 and entitled “Interchangeable Automated Mobile Robots with a Plurality of Operating Modes Configuring a Plurality of Different Robot Task capabilities”; U.S. Pat. No. 11,315,072 having issue date Apr. 26, 2022 and entitled “Inventory Management System and Method” and U.S. Patent Publication Number US2018/0341908 A1 having publication date Nov. 29, 2018 and entitled “Fully Automated Self Service Store”, all of which are incorporated by reference herein in their entirety.

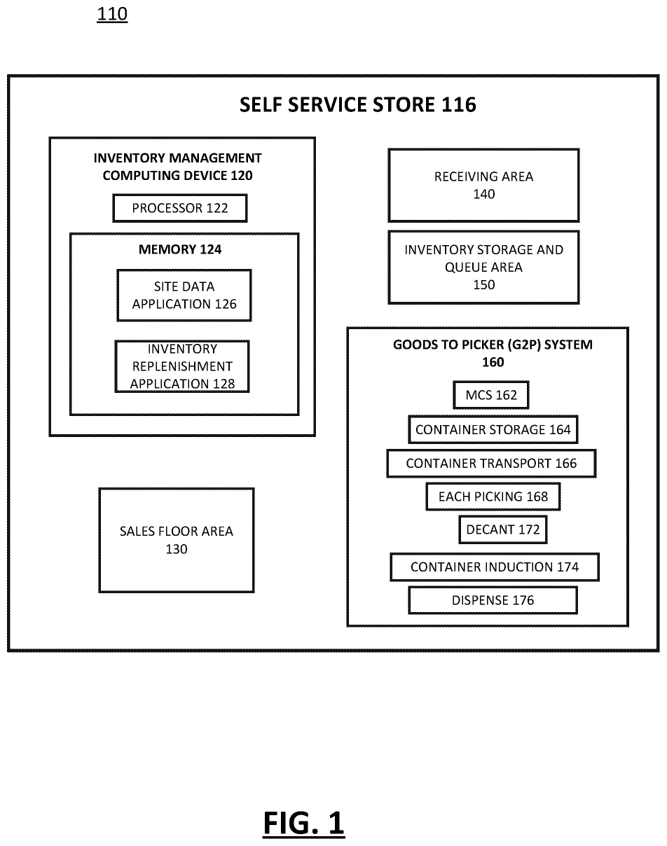

The store formats, operating systems and methods disclosed may be utilized in the foregoing examples and further by way of non-limiting example in applications such as summarized in FIG. 1, where FIG. 1 is a block diagram illustrating an example inventory replenishment management system 110 in a self-service store 116 in which some example embodiments of this disclosure may be implemented. The example inventory replenishment management system 110 may be implemented in a self-service store 116 and include an inventory management computing device 120, a sales floor area 130, a receiving area 140, an inventory storage and queue area 150 and a goods to picker (G2P) system 160, database, and network (not shown). Self-service retail store 116 is configured to fulfill retail orders in a “self-serve” model where customers select goods from sales floor area 130, pay for the goods and thereby fulfill their respective order in a “self-serve” model. Self-service retail store 116 is further configured to fulfill retail orders in an “e-commerce” model where customers select goods from a software application that may be computer, cellular or other device based which allows the customer to select goods in the order from the application to be fulfilled by self-service retail store 116 from inventory selected from within the G2P system 160 either alone or in combination with inventory selected from sales floor area 130. Instead of goods being picked and compiled into an order (from off of the sales floor) by the customer, goods that make up orders in an “e-commerce” model are typically picked and compiled onto an order by associates (or proxy or automation) from sales floor area 130 or G2P system 160 and delivered to the customer where the customer picks up or takes delivery of the order after it has been compiled.

G2P system, or area, 160 has material control system (MCS) 162, container storage 164, container transport 166, each picking module 168, decant module 172, container induction module 174 and dispense module 176. In one example, the G2P system 160 may be an order-fulfillment system for automated fulfillment of orders, for example received via an e-commerce model. The embodiments of the G2P system may for example include a multi-level rack structure that holds picking stock. The G2P system further includes workstations at which human or robotic pickers receive cases or containers of eaches for transport of the eaches into order containers. Mobile vehicles or robots are further provided, which are autonomous vehicles that perform various transfer and transport functions in the G2P system, including handling the movement of containers of goods between storage locations within the rack structure and the workstations. The G2P system may further include a centralized control system, comprising computers, software, and communications components, which manages the operation of the entire system. The G2P system may also include one or more input/output interfaces where cases or individual goods are inducted into the system to replenish the picking stock and completed orders are discharged from the system to be delivered eventually to customers. Containers used to transport goods in the G2P may be referred to herein as totes. Such totes may include subtotes, which are smaller totes, dividers or compartments within the totes for separating goods of different SKUs within a tote. It is understood that the G2P system may include a variety of other components, in addition to or instead of those described above.

The inventory management computing device 120 may be a local server or a computer terminal located in the retail store 116. The inventory management computing device 120 may be the centralized control system, or it may work in conjunction with the centralized control system. The inventory management computing device 120 may include a processor 121 and a memory 124.

The example inventory replenishment management system 110 may maintain a database storing product information for each of the products in the whole inventory of the retail self-service store 116. The product information may include a product name, a product code, a location code (e.g., zone, aisle, shelf, bin, etc.), a frozen status or chilled status, a quantity of the product displayed on a sales floor, a category, a department, a priority to be dispensed, a quantity of the product to be dispensed, a time to be dispensed, a scheduled pickup time, stock status, and a product supplier. The product code of each of the products can be a Universal Product Code (UPC) code, a Quick Response (QR) code or other standard codes associated with the product information saved in the database having site data application 126 stored in the memory 124. Products are delivered to the retail self-service store 116 and unloaded at a receiving area where products may be received packaged on pallets in cases. Each of the pallets may have common cases packaged thereon or alternately may have mixed cases packaged thereon. Data associated with the products received can be scanned and read where once the product is scanned as received by the retail self-service store 116 in the database, various information regarding the product may be retrieved from the database. For example, a location code of a product may be where the product is displayed in the sales floor 130, such as zone, aisle, shelf, bin, etc. Similarly, a location code of a product may also be where the product is stored in the G2P system 160 etc. The stock status of a product may be indicated as “out of stock”, “low stock”, or “regular stock”. The frozen or chilled products may have a higher unloading priority to be dispensed to the sales floor 130 or G2P system 160. The product information may further include product specifications, such as dimensions, weight, shape, color, etc. The database may store other product information, such as scheduled pickup times, pending customer orders, historical sales data, current and seasonal velocity or other attributes associated with each product sold in or fulfilled from the retail self-service store 116.

The inventory replenishment application 128 may be software modules or applications stored in the memory 124 and executed by the processor 121 of the inventory management computing device 120. The inventory replenishment application 128 may be configured to rank and order products received in receiving area and staged in inventory storage and queue area 150 to determine a priority, a time, and a quantity of each product to be dispensed to the sales floor 130 or G2P system 160 of the self-service retail store 116 as will be described in greater detail below. Further, the inventory replenishment application 128 may be configured to rank and order products already dispensed to the sales floor 130 to determine a priority, a time, and a quantity of each product to be dispensed again to replenish the G2P system 160 of the self-service retail store 116 as will be described in greater detail below. Inventory replenishment application 128 may be configured to analyze historical sales data of products sold to obtain sales patterns of the products. Further, the inventory replenishment application 128 may determine which products are needed for replenishment along with a quantity and a time for product replenishment. A sales pattern of a given product may include a sales amount, a velocity or sales rate, other sales information, or combinations of two or more of such sales information. The sales pattern of a product may be associated to timing information, such as a time of day, a time of week, a time of month, and a time of year. For example, some products might have higher sales amounts over weekends as compared to weekdays. Holidays may affect the sales patterns of certain products. The inventory replenishment application 128 may be configured to rank the products to determine a priority, a time, a quantity of each product to be dispensed to the sales floor 130 or G2P system of the self-service retail store 116 or other locations, based on sales patterns and the product information of each of the products. The inventory replenishment module 128 may determine the order of products to be moved based on the sales pattern and current stock status of the products to be ordered. Alternately, the inventory replenishment application 128 may be configured further as will be described or otherwise.

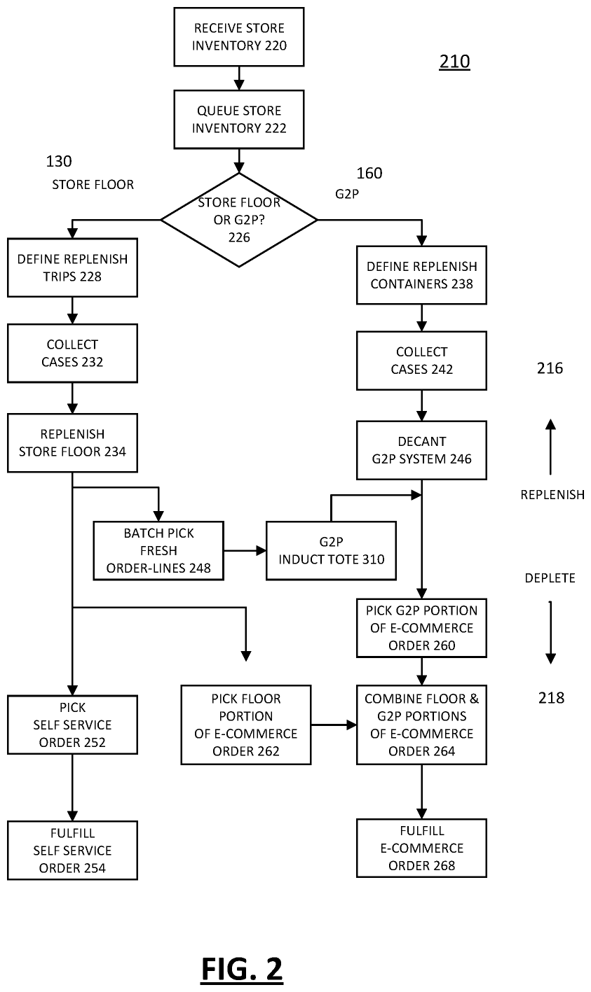

Referring now to FIG. 2, there is shown flow diagram 210 illustrating an example inventory management system 110 in a self-service store 116 in which some example embodiments of this disclosure may be implemented. The upper portion 216 represents store inventory replenishment whereas the lower portion 218 represents store inventory depletion. In practice, inventory replenishment and depletion may happen sequentially or more typically in parallel over time. Alternately, inventory replenishment and depletion may happen both sequentially and in parallel over time.

Store replenishment inventory may be received 220 at receiving area 140 and queued 222 at inventory storage and queue area 150. Inventory replenishment application 128 diverts 226 the inventory, primarily in case form, to either the store floor 130 or the G2P system 160. Inventory diverted to the store floor 130 may make up the sum of: 1) inventory needed to fulfill self-service orders and 2) inventory needed to make up the floor picked portion of e-commerce orders fulfilled by the store. Inventory diverted to the store floor 130 may have more or less components but is described here as two components for simplicity. The inventory needed to make up the floor picked portion of e-commerce orders fulfilled by the store may include inventory associated with batch picked fresh order-line goods 248 that are inducted into the G2P system 310 as will be described in greater detail. The inventory needed to make up the floor picked portion of e-commerce orders fulfilled by the store may also include inventory associated with floor picked portions of e-commerce orders 262, for example, bulky items that are unsuitable for induction into the G2P system or otherwise that are picked as order-lines for e-commerce orders. The replenishment inventory diverted 226 to the sales floor 130 and the replenishment inventory diverted 226 to the G2P system 160 may be mutually exclusive; i.e. different SKU's are diverted 226 to the sales floor 130 than those diverted 226 to the G2P system 160. Similarly, the replenishment inventory diverted 226 to the sales floor 130 and the replenishment inventory diverted 226 to the G2P system 160 may be common; i.e. where cases of the same SKU's are diverted 226 to both the sales floor 130 and to the G2P system 160, for example, where the velocity of the SKU's diverted 226 to both the sales floor 130 and to the G2P system 160 are high such that stocking both locations with higher quantities is warranted based on the demand the self-service orders and e-commerce orders individually.

Inventory diverted 226 to the store floor 130 is replenished by defining replenishment trips 228, collecting cases of inventory 232 based on those trips and stocking shelves 234 on the store floor to replenish the store floor. Inventory diverted 226 to the G2P system 160 is replenished by defining the replenishment containers or totes 238 that will contain the inventory, collecting cases of inventory 232 based on those containers or totes 238 that will be filled with the inventory and decanting 246 the inventory into the G2P system by stripping the cases of external packaging, loading the inventory contents into the totes through a decant process at decant portion 172 and inducting 174 the totes into the container storage structure 164 of G2P system 160.

Fulfillment of orders occurs in two models, self-service and e-commerce models. In the “self-serve” model, customers select or pick 252 goods making up an order from sales floor area 130, pay for the goods and thereby fulfill 254 their respective order in a “self-serve” model. In the “e-commerce” model, customers select goods from a software application that may be computer, cellular or other device based which allows the customer to select goods in the order from the application to be fulfilled by self-service retail store 116 from inventory picked 260 from within the G2P system 160 either alone or in combination with inventory picked 262 from sales floor area 130. Instead of goods being picked and compiled into an order (from off of the sales floor) by the customer, goods that make up orders in an “e-commerce” model are typically picked and combined 264 onto an order by associates (or proxy or automation) from sales floor area 130 or G2P system 160 and delivered to the customer where the customer picks up or takes delivery of the order to fulfill 268 the e-commerce order after it has been compiled.

There is a desire to include SKU's that require some secondary operation such as measuring weight or bagging, for example, many meat and produce SKUs in the G2P inventory assortment. AS used herein, SKUs requiring a secondary operation before they can be transferred to an order tote are referred to as fresh order-line goods (or fresh order-lines. In the event these fresh order-line SKU's are decanted into the G2P system before such secondary operations, for example, raw produce in totes then the G2P picking processes and workstations need to adapt to manage the added complexity of handling these products. Examples of such secondary operations may be for example inspection, waste-removal processes, tote cleaning, scanning, weighing, bagging or otherwise. This problem is overcome utilizing a batch pick for fresh order-line goods with a secondary sort-to-order operation. The process utilizes three main steps:
1. Batch-pick all fresh order-line goods by SKU on the store floor 248. Here, picked fresh order-line goods are bagged separately and put into a dedicated sub-tote where the processes in the P2G route picking are used except bagged fresh order-line goods are placed into sub-totes instead of customer bags, scanning the sub-tote barcode instead of the order-tote barcode.
2. These totes containing picked fresh order-line goods are inducted 310 into the G2P system as “transient” product totes where the contents of each sub-tote are targeted to a specific customer order.
3. At the picking workstations, these “transient” product totes are picked 260 from at the G2P workstation with the contents directed into the appropriate order totes for the targeted specific customer orders.

Here, the batch pick is a manual batch pick with a secondary sort-to-order operation happening within the G2P system where a manual batch-pick with automated secondary sort-to-order operation may be used to improve picking efficiency, even with two touches required. Here, the secondary operation(s) do not happen within the G2P system and instead happen on the store floor (or other location within or separate from the store floor) instead of at the picking workstation within the G2P system thus keeping the high efficiency picking at the G2P picking workstation intact.

The batch pick and secondary sort operation may be applied to fresh order-line good SKUs in the fresh market. As used herein, fresh order-line goods include for example products such as produce, meats, seafood, flowers, etc. Fresh order-line goods may further include items obtained from a deli or butcher within the store, either when ordered by a customer, or prepackaged by the deli or butcher. Such fresh order-line goods may include for example meats (ground or whole), processed products made from meats, deli meats, cheeses, side dishes (coleslaw, potato salad, other salads etc.), specialty items from the deli section, or other items that have been packaged into different sizes or amounts, which sizes or amounts, and the price therefor, are indicated by a bar code or other digital identifier on the packaging. In a store that has an assortment of 40,000 SKUs, these fresh order-line goods might represent only 3,000 SKUs but may account for 20%-25% of eaches ordered online. Unlike packaged goods, fresh order-line goods of the same product may differ significantly one from another. For example, one steak is not identical to another in marbling, and produce items can differ in ripeness and blemishes. To maintain customer satisfaction with fresh order-line goods, pickers may exercise judgement in selecting individual fresh order-line goods of high quality, and it is cost-effective for this selection process to be done on the store floor rather than at a G2P picking station where the additional operator time would be limiting machine throughput. Further, many of these fresh order-line goods are “catchweight” items requiring the selected quantity to be weighed as a secondary operation in order to be priced and assigned a unique identifier, by way of non-limiting example, with price-embedded barcodes. Price-embedded barcodes, also known as random weight, variable price, or type 2 barcodes, have the item's PLU (price look-up) item code and total price encoded into the barcode. These barcodes may be printed using a label printing scale for sell-by-weight products at a deli counter or butcher, for example. Once again, performing this process at a G2P workstation would slow down system throughput and therefore would be more costly than weighing on the floor. Further, the high perishability of these fresh order-line goods and the potential for contamination to other products make it a candidate to keep these products out of the G2P system and on the store floor (or elsewhere) easily accessible and visible to store associates. Here, the location of the fresh market along the perimeter of the store may translate to travel distances much shorter for the order-pickers than within the labyrinthine center-store aisles filled with packaged goods.

Concurrent batch picking or nightly batch-picking may be utilized to batch-pick order-lines for fresh items by SKU on the store floor. G2P storage capacity may be provided to hold “fixed” or “static” inventory that is used to fulfill future (anticipated) orders, where also a portion of G2P storage capacity may also be allocated to hold “transient” or “dynamic” inventory to fulfill specific known orders, for example, by these totes containing batch picked fresh order-line goods into G2P storage as “transient” product totes. Here, static storage corresponds to persistent inventory, whereas transient storage corresponds to dynamic inventory. In accordance with the present technology, the store fulfills orders by combining picks in the G2P system from (a) the G2P static storage and (b) the G2P transient storage by these totes containing batch picked fresh order-line goods into G2P storage as “transient” product totes. The specific composition of allocated storage capacity in the G2P system, in terms of number of totes, and number and sizes of sub-totes, would be determined algorithmically and can change from day to day.

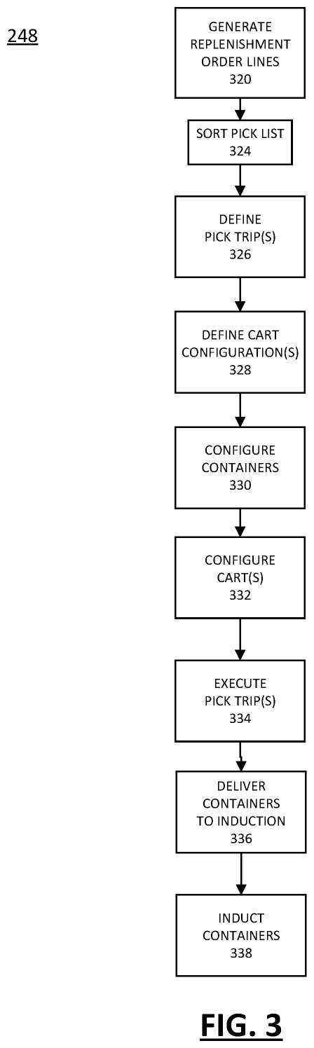

Referring now to FIG. 3, there is shown the P2G batch picking process 248 having the following steps. On intervals, for example, each day, software in the G2P automation generates a list of fresh order-line goods 320 to be batch picked, with each order-line specifying the identity of the fresh order-line good SKU to be replenished, the shelf-position within the fresh market where the SKU is located, the desired quantity (may be number, weight, size or otherwise) to be picked, and the size of the compartment into which the fresh order-line goods are to be placed (e.g., either ¼-tote or ⅙-tote, though can be other sizes, such as for example ⅓-tote). This pick list is then sorted 324 based on location of the SKUs and subdivided 326 into trips, each trip requiring a picker to push a cart on a specified path and pick the order-lines on the pick-list in the sequence of location. The order-lines to be batch picked may be sequenced such that a picker picks multiple order-lines of the same fresh market SKU for efficiency. This approach facilitates the potential for only a single picking pass through the entire zone where all order-lines for each SKU may be picked on each stop to minimize the picker travel time and increase pick density assuming optimal mix of sub-tote sizes in the totes on the cart used for picking. This approach to picking may be done during off peak hours, including night/early-morning hours without customers in store, or times when there are a low number of customers in the store, resulting in cost improvements due to faster movement through zone in addition to avoiding impacting customer in-store experience thus preserving qualitative advantage of picking in G2P system. The cart may have features allowing for secondary operations, for example, such as scanning, weighing, bagging, creating labels or secondary operations. The number of trips and the path of each trip will depend on the number of order-lines, the mix of defined 330 compartment sizes into which the eaches will be placed, and the number of totes (containers) that can be loaded onto the cart 328 for each trip. A cart is then set up and configured 332 for each trip. Every cart on every trip may be loaded with the maximum number of totes that it can carry, though the mix of totes with ¼-tote compartments and ⅙-tote compartments will vary depending on the requirements for each trip. These totes will typically come out of the G2P system following a defragmentation process that consolidates empty compartments into these totes identified for fresh batch picking with or for containment of subtotes. Each tote and each compartment (may be with a sub tote) within the tote have some form of indicia with a unique identifier (e.g. barcode), all of which are registered within the system along with the association/configuration between totes and compartments. The system may have these indicia and locations stored as part of an automated defrag and confirmation process within the G2P system or alternately these indicia may be scanned as part of the batch picking process. Ideally, each cart is configured to include a storage array that holds all of the totes to be filled on the trip, and a receiving shelf that holds two totes at an ergonomically optimal height, for example, one tote configured with ¼-tote compartments and the other with ⅙-tote compartments. A picker then executes 334 each trip by pushing the cart along the specified path, stopping sequentially at the location of every SKU on the location-sorted pick list, and transferring up to the specified quantity of every SKU into a compartment of the specified size in one of the two totes on the receiving shelf (provided that the requested eaches are actually on the shelf available to be picked). A computational device mounted to the cart (or worn by the picker) may provide to the picker the necessary information for each pick (SKU identity, shelf location, quantity, and size of compartment in which to put the picked eaches), and the picker may use a barcode scanner to scan both the GTIN barcode present on the picked eaches and on the compartment into which the eaches are put. (A possible scanner configuration may be a finger-mounted “ring” scanner that provides the picker full use of both hands at all times.). Once a trip has been completed, the picker pushes and delivers 336 the cart full of filled totes to an induction station 174 connected to the G2P picking system 160, and transfers the totes from the cart into the G2P system to be placed into tote storage 164 as product totes ready to supply eaches to be picked at the G2P picking station to fill future customer orders. The procedure by which these totes are inducted into the G2P system will be specific to the system. All of this fresh batch picking can be done during normal operation or off peak alternately allowing for better floor flow to the store customers and less congestion overall.

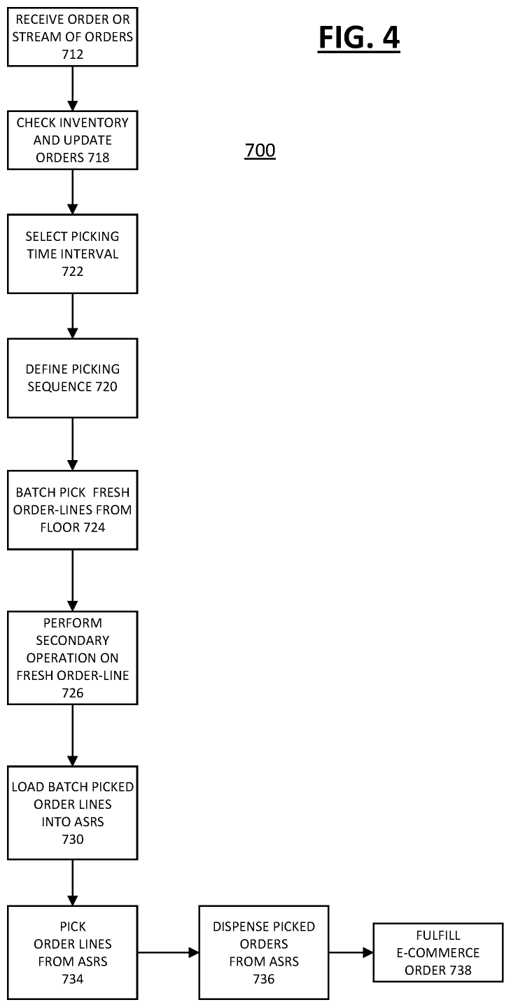

Referring now to FIG. 4, there is shown a flow diagram 700 illustrating an example order fulfillment system flow. The method will be described as a system where orders are picked and put into the automation. Here, the picking to order is done in the G2P system after the floor-based batch picking of fresh order-line items. Here, orders are fulfilled by batch picking fresh items from the store inventory, at store level and loading the batch picked items into a G2P system where a subsequent pick at a picking workstation of the G2P system completes picking of the order-lines in a given order. The ASRS may be for direct customer dispense and may be as disclosed in US Patent Publication Number US2017/0313514A1 with publication date Nov. 2, 2017 and entitled “Order Fulfillment System” hereby incorporated by reference in its entirety. Alternately, any ASRS system may be utilized. In the method of FIG. 4, an overnight or off-peak picking schedule may be utilized to pick the batch picked fresh order(s) where a rack-based batch pick cart may be utilized to perform the batch picking of individual order-lines. Unloading may also be direct to parking lot dispense from the same ASRS filled from the interior store. Racks and hardware for direct customer dispense may be as disclosed in US Patent Publication Number US2018/0194556A1 with publication date Jul. 12, 2018 and entitled “Interchangeable Automated Mobile Robots with a Plurality of Operating Modes Configuring a Plurality of Different Robot Task Capabilities” incorporated by reference herein in its entirety.

In method 700 shown in FIG. 4, customer orders are received 712 some time before, for example, hours or the day before they are to be picked up, for example, before 10 pm, a predetermined time or otherwise. Inventory is checked 718 for availability and fresh order-lines compiled where orders are a known and where optimized routes may be defined for the pickers. The picking sequence 720 may be as described with respect to FIG. 3 above. Batch picking of the fresh order-line items may be over a given selected picking time interval 722 which may vary by season, time of week or otherwise, for example, picking time interval between 10 pm and 4 am, where pickers manually batch pick 724 items from the fresh inventory. Here, this pick period could be adjusted to accommodate store replenishment before or after this batch picking period. The night batch picking has features including where batch pickers can pick very efficiently since all orders are known and optimized routes may be defined for the pickers. Further, store customers are not impeding the picking operation due to off peak hour picking (here, retail customers may or may not be present). This feature also improves the customer shopping experience by picking at night or during off-peak hours so as not to impede customer traffic with the pickers and picking carts. An additional feature is provided where night batch picking or off-peak picking allows a given picker to achieve higher pick rates and hence higher cost efficiency. After the fresh order-line is picked (724), the secondary operation is performed (726). As noted above, this secondary operation is some sort operation or other operation required to be performed on the fresh order-line goods before it can be placed in the final order. Secondary operations include for example bagging, weighing and/or scanning of the fresh order-line goods.

Upon completion of a given batch pick and secondary operation, batch pickers load 730 the picked orders into an ASRS, which may be a mobile robot-based system or other suitable ASRS. In one aspect, the cart or rack used for batch picking may be attached to the Alphabot structure to allow direct unloading of totes containing full customer orders and reloading with empty totes for the next batch pick run. Such a system is described in U.S. Provisional Patent Application No. 63/013,504 with filing date Apr. 21, 2020 and entitled “Transport Rack Cartridge” incorporated by reference herein in its entirety. The storage ASRS may have ambient, chilled and frozen temperature zones. Alternately, the storage ASRS may have an all ambient temperature zone and contain Passively Cooled Totes (Chilled and Frozen), for example, as disclosed in U.S. patent application Ser. No. 16/831,468 with filing date Mar. 26, 2020 and entitled “Tote Handling for Chilled or Frozen Goods” incorporated by reference herein in its entirety. After the batch picked fresh items are inducted into the ASRS, the complete order may be picked 734 within the ASRS at the G2P picking station and the fresh batch picked and G2P each picked items combined to make up the given order. When the order is ready to be fulfilled, orders are then dispensed 734 from the ASRS and the order then can be fulfilled 738. In the embodiment disclosed and by way of example, the ASRS may have the ability to present the fully consolidated order directly to the customer, thereby eliminating the significant labor cost associated with dispensing orders to customers manually. In alternate aspects, the order may be fulfilled to the customer by any suitable method.

### INCORPORATED MATERIAL

As noted above, the present technology may be used in the context of order fulfillment and automation-based technology, at least some of which is disclosed in published applications previously incorporated by reference and at least some of which is set forth below.

U.S. Patent Publication 2017/0313514 (“the '514 Reference”) discloses a system including workstations, a deck and storage locations as shown in FIGS. 54A-G. FIG. 54A of the '514 Reference illustrates an exemplary configuration of workstations 5500 where at least three workstations 5500 are disposed on each storage level, while in other aspects any suitable number of workstations may be disposed on each storage level. The workstations 5500 for the different levels may be vertically offset from one another such as being stacked one above the other or stacked in a staggered arrangement. In one aspect, each workstation 5500 is communicably connected to two transit decks 5550A, 5550B, while in other aspects each workstation 5500 may be communicably connected to any suitable number of transit decks. In one aspect, each transit deck 5550A, 5550B may correspond to a respective storage level while in other aspects the transit decks 5550A, 5550B may correspond to a common storage level (e.g. there is more than one transit deck associated with each storage/picking level). In another aspect, there may be towers that are located on or otherwise connected to (or disposed within) the transit decks (or aisles) that communicably connect one or more of the transit decks 5550A, 5550B (or aisles) of the different storage levels to from a travel loop with another tower so that bots 5100 (FIG. 54G of the '514 Reference) may travers between the stacked transit decks 5550A, 5550B (or aisles) to any desired/predetermined level of the storage structure. The workstations 5500 are configured to accommodate a picker 5520 that transports one or more eaches from a tote (e.g. a P-tote) on one of the bots 5100 to a “put” location in a tote (e.g. an O-tote) on another one of the bots 5100. The workstations 5500 may be arrayed at multiple elevations where human or robotic pickers remove eaches from product Totes (P-totes) and place them into either order Totes (O-totes) or a mobile robot, depending on the system configuration and in a manner substantially similar to that described above. A workstation 5500 is disposed at each transit deck level so that bots 5100 on each transit deck have access to a workstation 5500. In the exemplary aspect illustrated in FIG. 54G of the '514 Reference, six transit deck levels are shown, with two levels each being connected to a common workstation 5500. However, in other aspects any suitable number of transit deck levels may be connected to a common workstation 5500.

FIG. 54A of the '514 Reference shows a workstation 5500. Each of the conveyance lanes 5501, 5502, 5503, 5504 has a respective entry and/or exit 5500E in communication with a respective transit deck 5550A, 5550B. As can be seen in FIG. 54A of the '514 Reference, conveyance lanes 5501, 5504 have entry/exits 5500E in communication with transit deck 5550B while conveyance lanes 5502, 5503 have entry/exits 5500E in communication with transit deck 5550A. The conveyance lanes 5501-5504 include rails WRR. As can also be seen in FIG. 54A of the '514 Reference, elevation towers 5190TWA-5190TWD connect stacks of conveyance lanes to each other. As an example, elevation towers 5190TWA, 5190TWB connect conveyance lanes 5503, 5504 so that bots 5100 can traverse between the conveyance lanes 5503, 5504. Elevation towers 5190TWC, 5190TWD connect conveyance lanes 5501, 5502 so that bots 5100 can traverse between the conveyance lanes 5501, 5502.

In one aspect, one or more of the conveyance lanes 5501-5504 and towers 5190TWQ-5190TWD may be angled (e.g. tilted or raked) relative to the transit decks 5550A, 5550B and the operator platform 5510 so that when the P-totes and O-totes are presented to the picker 5520 by the respective P-bot and O-bot, the P-totes and O-totes are angled so that the picker 5520 can view and access the P-totes and O-totes for picking and placing eaches from pick/place positions defined by the towers 5190TWQ, 5190TWC adjacent the pick station 5530. In other aspects, the conveyance lanes 5501-5504 and towers 5190TWA-5190TWD may have any spatial relationship with the pick station 5530 and/or transit decks 5550A, 5550B for presenting the totes to the picker 5520 in any suitable spatial orientation.

In one aspect, the conveyance lanes 5501-5504, the elevation towers 5190TWA-5190TWD and the pick station 5530 have a symmetric structure with independent product bots (P-bots) and order bots (O-bots) paths and positions. In this aspect there may be lateral symmetry (in direction 5599) so that there is a left/right symmetrical arrangement. For example, the left/right symmetrical arrangement may be such that P-bots carrying P-totes are arranged on the right side of the workstation 5500 while O-bots carrying O-totes are arranged on the left side of the workstation 5500. In other aspects, the P-bots and P-totes may be on the left side of the workstation 5500 while the O-bots and O-totes are on the right side of the workstation 5500.

In one aspect, there are dedicated bot flow entry and exit conveyance lanes for both the P-bots and O-bots. For example, the flow of bots to the pick station 5530 may be such that the bots travel from lower conveyance lanes to upper conveyance or in other aspects, from upper conveyance lanes to lower conveyance lanes. For example, where bots travel from lower conveyance lanes to upper conveyance lanes, P-bots carrying eaches to be picked enter one or more lower/bottom conveyance lane(s) 5501, traverse tower 5190TWC to one or more upper conveyance lane(s) 5502 so that the each(es) can be picked where the P-bot exits the workstation using the one or more upper conveyance lane(s) 5502. Similarly, e.g., O-bots carrying O-totes to which eaches are to be placed enter one or more lower/bottom conveyance lane 5504, traverse tower 5190TWA to one or more upper conveyance lane(s) 5503 so that the each(es) can be placed where the O-bot exits the workstation using the one or more upper conveyance lane(s) 5503. In other aspects, the entrance of bots to the workstation may be timed such that the bots can enter and exit from both the upper conveyance lanes 5502, 5503 and the lower conveyance lanes 5501, 5504 where the towers 2190TWA-5190TWD are employed to route bots past one another such as when bots are entering and exiting a common conveyance lane 5501-5504. In the examples, described above, the flow of P-bots carrying P-totes and the flow of O-bots carrying O-totes are both generally in a common direction, such as both in the direction of arrow 5598 from lower conveyance lanes to upper conveyance lanes or both in the direction of arrow 5597 from upper conveyance lanes to lower conveyance lanes. However, in other aspects, the flow of one or more of the P-bots and O-bots may be in the direction of arrow 5597 from upper conveyance lanes to lower conveyance lanes. For example, the flow of P-bots and P-totes may be in the direction 5598 while the flow of O-bots and O-totes may be in the direction 5597 or vice versa.

In one aspect, each side of the workstation 5500 (e.g. the product side and the order side) has dedicated flow direction elevation towers. For example, elevation tower 5190TWC on the product side of the workstation 5500 may be dedicated to the upward flow of bots while elevation tower 5190TWD on the product side of the workstation 5500 may be dedicated to the downward flow of bots or vice versa. Similarly, elevation tower 5190TWA on the order side of the workstation 5500 may be dedicated to the upward flow of bots while elevation tower 5190TWB on the order side of the workstation 5500 may be dedicated to the downward flow of bots or vice versa. The dedicated flow of bots for each tower 5190TWA-5190TWD on the respective order or product side of the workstation 5500 generates, for example, an elevation flow loop in one or more of directions 5597, 5598 between the levels of conveyance lanes 5501-5504 on the respective order and product sides of the workstation 5500 in a manner substantially similar to that described above. As noted above, while only two conveyance lanes are shown stacked one above the other on each side of the workstation, in other aspects, each side of the workstation may have any suitable number of conveyance lanes stacked one above the other, such as more or less than two conveyance lanes. Where more than two conveyance lanes are provided, stacked one above the other, on the product side and/or the order side of the workstation 5500 the towers 5190TWA-5190TWD may have intermediate entrance and exits that allow bots to enter/exit the towers from the intermediate conveyance lanes disposed between the uppermost and lowermost conveyance lanes 5502, 5501 of the stack of conveyance lanes.

Referring to U.S. Patent Publication No. US2018/0134492 (“the '492 Reference”), FIG. 4A depicts a representative conceptual internal layout of the store 300 and how each of the areas of the store 300 relates to one another. In particular, FIG. 4A of the '492 Reference depicts the shopping section 302, the automated fulfillment section 304, a delivery fulfillment section 308, and a receiving section 310. Although the different areas represented in FIG. 4A of the '492 Reference are represented within a single plane, the areas can be divided on multiple floors of a store 300. During operation of the store 300, all transactions occur through one or more of these areas. In accordance with an example embodiment of the present invention, customers utilize the entrances 306 to enter 402 and exit 404 the shopping section of the store 300. Once inside the shopping section 302 of the store 300, customers can place orders for goods to be fulfilled by the automated order fulfillment and can shop for non-fungible goods within the non-fungible goods fulfillment section of the store, as discussed in greater detail herein.

Customer orders to be fulfilled by the automated order fulfillment will be processed by the automated system within automated fulfillment section 304, as discussed in greater detail herein. When the automated order fulfillment has been completed, the automated picked goods will be provided 406 to the delivery fulfillment section 308, as discussed in greater detail herein. Similarly, when customers have completed picking non-fungible goods within the shopping section 302, the customers will provide 408 the goods to the delivery fulfillment section 308, as discussed in greater detail herein. For example, the customers can place a tote or basket with their goods through a window to the delivery fulfillment section 308. At the delivery fulfillment section 308 goods provided 406 from the automated fulfillment section 304 and goods provided 408 from the shopping section 302 will be combined into a single order for delivery 410 to the customer, as discussed in greater detail herein.

Continuing with FIG. 4A of the '492 Reference, the store 300 can include the receiving section 310 for receiving goods from various suppliers and/or manufacturers. The receiving section 310 can be included within a “back end” of the store that is not seen by customers. When goods are delivered to the receiving section 310 the goods are identified as non-fungible goods for storage within the shopping section 302 or fungible goods for storage within the automated fulfillment section 304. The non-fungible goods will be transferred 414 to the shopping section and stored in a manner to provide non-fungible goods fulfillment. Similarly, the fungible goods will be transferred 416 and stored in a manner suitable for automated order fulfillment (e.g., stored in totes and place into a storage rack).

FIG. 4B of the '492 Reference depicts a more detailed view of the internal structure of the store 300 as discussed with respect to FIG. 7A. In particular, FIG. 4B of the '492 Reference depicts a detailed view of the shopping section 302, the delivery fulfillment section 308, a plan view of the automated fulfillment section 304, and how those sections relate to one another. The shopping section 302, as depicted in FIG. 7B, includes entry and exit points 306, a mock market 600, and a pass through 408 to the automated fulfillment section 304. The mock marketplace 600 includes a wall of ordering screens 602, a plurality of physical shelving units 604 and display cases of stands 606, and a plurality of shopping terminals and checkout kiosks 619. As would be appreciated by one skilled in the art, the mock marketplace 600 can include any combination of the elements depicted in FIGS. 7A-7C. Additionally, FIG. 4B of the '492 Reference depicts the delivery fulfillment section 308 of the store 300. The delivery fulfillment section 308 includes a plurality of transfer stations 611 which completed orders of goods are delivered for acceptance by customers.

FIG. 4C of the '492 Reference depicts a more detailed view of the automated fulfillment section 304, the delivery fulfillment section 308, a basic view of the shopping section 302, and how those sections relate to one another. The automated fulfillment section 304 includes the storage rack 613 system configured to hold totes of inventory accessible by the robots and further configured to enable the robots to pull inventory totes and deliver the totes to pickers at picking workstations 614 for automated order fulfillment. In accordance with an example embodiment of the present invention, the delivery fulfillment section 308 includes a consolidation section in which goods from the automated fulfillment section 304 and goods from the shopping section 302 are combined and consolidated into order totes for delivery to customers at the transfer stations 611. As would be appreciated by one skilled in the art, the consolidation can occur within the same physical space as the automated fulfillment section 304 or in a separate physical space.

In accordance with an example embodiment of the present invention, the store 300 of the automated-service model 100 includes a “front end” including an entry lobby, the shopping section 302 for non-fungible-goods, and associated work areas. As would be appreciated by one skilled in the art, the front end does not necessarily need to be located at a front of the store 300 or on a ground level of the store 300. The vast majority of floor space within the shopping section 302 is devoted to a non-fungible-goods market (e.g., produce, fresh goods and other non-fungible goods) and associated work spaces, which can be the focal point of the store 300 from a customer perspective. The shopping section 302 includes “non-fungible” goods such as produce, meat, seafood, many cheeses (primarily random-weight), deli, floral, bakery, and prepared foods. Typically, non-fungible goods will be sold from display fixtures or stands 606 with as many as three different pricing methods, including but not limited to “random dollar” (fungible with a price barcode), random weight (loose items, especially produce, priced based on item weight), and random count (loose items priced based on number of eaches). These non-fungible goods can also be sold at service counters that offer the customer more opportunity to customize ordered products according to their individual tastes and preferences.

In accordance with an example embodiment of the present invention, the shopping section 302 of the store 300 is similar in appearance to perimeter departments within traditional self-service grocery stores with technology enhancements, related to the automated-service model, to improve customer convenience and reduce retailer operating costs. The technological improvements for the shopping section 302 are primarily related to how customers shop for goods and exchange funds for those goods. One such technological improvement is the implementation of shopping terminals to be utilized in combination with the automated-service model. The shopping terminals are devices utilized by customers as the primary interface to select, scan, enter, and/or store goods for an order to be placed during shopping trip, including an exchange of funds for the order. In particular, the shopping terminals can be utilized to place orders for both fungible goods (to be picked by the automated order fulfillment) and non-fungible goods within the non-fungible goods fulfillment.

As would be appreciated by one skilled in the art, the shopping terminals can be any device configured to identify a particular good (e.g., via scan, photo, etc.) to be added to a shopping list. For example, the shopping terminals can be a portable scanning device or one or more fixed touch screens located within the shopping section 302.

Referring to U.S. Patent Publication Nos. US2018/0150793 and US2018/0194556, FIGS. 2A-2F of US2018/0194556 (“the '556 Reference”) show an example embodiment of the present invention where customer orders for fungible goods are fulfilled by an automated system within automated fulfillment section 204. When the order for automated fulfillment has been completed, the totes 232 containing the fungible goods picked by the automated mobile robots 122 and pickers 234 will be provided to the delivery fulfillment section 208 (e.g., via path 408). Similarly, when customers have completed picking non-fungible goods within the shopping section 202, the customers will provide the goods to the delivery fulfillment section 208 (e.g., via path 410). In accordance with an example embodiment of the present invention, the delivery fulfillment section 208 includes a consolidation section 240 in which goods from the automated fulfillment section 204 and goods from the shopping section 202 are combined and consolidated into order totes 232 for delivery to customers at one or more transfer stations 242.

At the consolidation section 240 of the delivery fulfillment section 208, the fungible goods provided from the automated fulfillment section 204 and non-fungible “fresh goods” provided from the shopping section 202 will be combined into a single order for delivery to the customer at a transfer station 242. In particular, the consolidation section 240 includes a merge module that combines eaches of goods picked from the automated fulfillment section 204 with eaches of goods picked from the shopping section 202 deposited at the one or more goods drop-off transfer stations 242. The combined eaches of goods from both sections 202, 204 form a delivery bundle (e.g., one or more totes 232 of goods) and the automated mobile robots 122 transfer the completed delivery bundle to transfer station 242 which receives and stores a delivery bundle in a designated location until a customer arrives to take possession of the delivery bundle.

In accordance with an example embodiment of the present invention, during consolidation, a plurality of automated mobile robots 122 are tasked to retrieve totes 232 of goods from the various sections 202, 204, and transfer those totes 232 to the merge module of the consolidation section 240. Based on the quantity of goods, one or more of the plurality of automated mobile robots 122 or one or more new automated mobile robot(s) 122 can retrieve the delivery bundle and transfer the bundle to the appropriate transfer station 242. Each of the tasks as it related to FIG. 2A-2F of the '556 Reference is carried out within the delivery mode of operation with different task demands provided to each of the automated mobile robots 122 performing each specific task (e.g., delivering goods from the shopping section 202, delivering goods from the automated fulfillment section 204, delivering the completed delivery bundle to the transfer station 242, etc.). As would be appreciated by one skilled in the art, the consolidation can occur within the same physical space as the automated fulfillment section 204, the delivery section 208, or in a separate physical space.

FIGS. 2A-2F of the '556 Reference depict exemplary views of the delivery fulfillment section 208 and a conceptual relation of the delivery fulfillment section 208 to the automated fulfillment section 204 and the shopping section 202. In accordance with an example embodiment of the present invention, the delivery fulfillment section 208 includes a plurality of transfer stations 242 configured for customers to pick-up their orders. The transfer stations 242 are configured for the delivery of the goods directly to a customer or customer vehicle in a variety of ways.

In accordance with an example embodiment of the present invention, the replenishment section 206 of the automated store 300 is configured to receive shipments of goods from various suppliers and/or manufacturers. The replenishment section 206 is included within a “back end” of the store that is not typically seen by customers. FIG. 8C depicts an exemplary view of the replenishment section 206 and the relation of the replenishment section 206 to the other sections of the automated store 300. In particular, FIG. 2C of the '556 Reference depicts the replenishment section 206 including a docking area for receiving cases of goods (e.g., via truck). In accordance with an example embodiment of the present invention, the cases of goods can be received either as pallets of cases 250 or as portable racks of totes 232 with goods stored therein. The portable racks 252 of totes 232 can be received from a distribution center designed for implementation with the automated store 300. Initially, regardless of shipping method, when goods are delivered to the replenishment section 206 the goods are identified as non-fungible goods for storage within the shopping section 202 or fungible goods for storage within the automated fulfillment section 204. Based on the determination of fungible goods or non-fungible goods, the received items will be allocated to the designated areas accordingly. In particular, the non-fungible goods will be transferred to the shopping section 202 (e.g., via path 406) and the fungible goods will be transferred (e.g., via path 404) and stored in a manner suitable for automated order fulfillment (e.g., stored in totes 232 and placed into the storage rack 230).

As would be appreciated by one skilled in the art, depending on if the goods are received by pallets of cases 250 of portable racks 252 or totes, the items will be received into inventory of the automated fulfillment section 204 through different methodologies. In accordance with an example embodiment of the present invention, the replenishment section 206 includes a decanting station 254 configured to replenish goods to the automated fulfillment section 204, as depicted in FIG. 8D. The decanting station 254 can be utilized to replenish goods received from manufacturers, suppliers, and returns from customers. The decanting process includes transferring products from pallets of cases 250 and/or customer returns into totes 232 to be stored within the storage rack 230 of the automated fulfillment section 204.

In operation, the automated mobile robots 122 are configured to assist and/or carry out various operations throughout the automated store 300. Each of the various operations is carried out by allocating (e.g., via the central controller) the automated mobile robots 122 in one or more modes of operation. The modes of operation include, but are not limited to, a replenishment mode, a defragmentation mode, an order fulfillment mode, and a delivery mode. The replenishment mode includes receiving eaches of goods and depositing the eaches of goods in designated storage totes and/or storage locations within the storage rack 230, the defragmentation mode includes organizing totes 232 and consolidating sub-totes stored within totes 232, the order fulfillment mode includes retrieving order totes from the storage rack 230 and delivering the order totes to the delivery section 208, and the delivery mode includes receiving delivery bundles and transporting the delivery bundles to designated locations at the pick-up transfer stations 242. In accordance with an example embodiment of the present invention, each of the different modes of operation is executed by an automated mobile robot 122 of the same design. In other words, a single automated mobile robot 122 is capable of carrying out the tasks required by each of the modes of operation without modification.

In accordance with an example embodiment of the present invention, the totes 232 are interchangeable and are designated with different identifiers for the automated mobile robots 122. That is, while the totes 232 are the same structurally such that they are interchangeable in the tasks that the totes 232 can be utilized for based on the designation associated therewith. The totes 232 are designated based on their capacity as well as the mode of operation in which they are being utilized. In particular, the interchangeable totes 232 are designated as empty storage totes when empty (e.g., no items included therein), designated as storage totes 232 or product totes 232 when containing eaches of goods (e.g., inventory), designated as order totes when containing eaches of goods for customer orders, or combinations thereof. In operation, the system 100 provides the designations and the designations assist the automated mobile robots 122 to identify which totes 232 are to be utilized for which mode of operation. For example, if an automated mobile robot 122 is instructed to retrieve and empty tote 232 as part of a mode of operation, the automated mobile robot 122 will know or be instructed to the location of a tote 232 designated as an empty tote(s) 232.

In accordance with an example embodiment of the present invention, the central controller can identify and track the locations of all the automated mobile robots 122, the totes 232, the respective designations (e.g., modes or operation or tote designation) in the system and eaches within each sub-totes contained within each tote 232. The identification of the locations for all of the automated mobile robots 122 and totes 232 can further be utilized by the central controller when allocating automated mobile robots 122 to different modes of operations. In particular, the central controller can identify all of the automated mobile robots 122 that are located within a particular section and instruct those automated mobile robots 122 to perform a particular mode of operation within that section. The central controller attempts to level-load the automated mobile robots 122 to ensure all necessary store 300 operations are completed with the fewest number of automated mobile robots 122.

When the central controller wants to assign a mode of operation to one or more automated mobile robot(s) 122, the central controller will transmit a task demand to the one or more automated mobile robot(s) 122, instructing what tasks to carry out in accordance with a mode of operation. In particular, the task commands include instructions related to a destination and picking or placing a tote at the destination. Additionally, the task demand can include specifying one or more totes 232 to utilize during the mode of operation and the origination/destination locations for the one or more totes 232. As would be appreciated by one skilled in the art, although the present invention is discussed with respect to providing instructions, demands, etc. via the central controller, some or all of the control elements may be distributed throughout the system including logic stored within the automated mobile robots 122 themselves.

In accordance with an example embodiment of the present invention, the replenishment mode includes an automated mobile robot 122 propelling itself through the storage rack 230, delivering a partially filled or empty tote 232 to the decanting station, receiving a tote 232 (e.g., a storage tote or product tote) with goods for replenishment, and/or transporting the replenished tote 232 of goods to a storage location within the storage rack 230. As would be appreciated by one skilled in the art, the totes 232 are interchangeable and can be utilized within the modes of operation interchangeably, such that product totes can be utilized for replenishment, storage, and delivering product to workstations for order fulfillment. The particular tote designation relates to the function the tote is performing at the time, based at least in part on the contents of the tote. When operating in replenishment mode, the automated mobile robot 122 will receive multiple task demands related to where to traverse for receiving the tote 232 of goods for replenishment, where to traverse to deposit the replenished tote 232 of goods within the storage rack 230. As would be appreciated by one skilled in the art, the task demands will repeat these steps for each new tote 232 for replenishment.

Additionally, depending on how the goods are provided at the replenishment section 206, the automated mobile robots 122 may execute the same mode of operation in a different manner as influenced by different task demands. For example, the mobile robots 122 will be instructed to traverse different sections within the replenishment section 206/automated fulfillment section 204 when receiving goods originating from pallets of cases 250 than when receiving goods originating from portable racks 252 of totes 232. FIG. 8C depicts how the initial location for receiving totes 232 for replenishment will vary based on shipping methodology. In particular, when goods are received via pallets of cases 250, the pallet of cases 250 will be unloaded, either through an automated process or via a human operator, and transported to a decanting station 254.

Referring to U.S. Patent Publication No. US2018/0247257 (“the '257 Reference”), FIG. 1 shows an illustrative system 10 for implementing the steps in accordance with the aspects of the present technology. As seen in FIG. 1 of the '257 Reference, palletized cases of goods 12 are received at one or more regional distribution center (RDC) 14 where the regional distribution center supplies palletized mixed cases of goods 16 to market distribution center (MDC) 18 where the market distribution center decants and stores like eaches in various sized subtotes 24 and supplies totes containing mixed each subtotes 20, 22 to market 26 as will be described in greater detail below. As an alternative, shipments may be made to stores or markets in Totes directly from the distribution center with no market distribution center or the function of the regional distribution center and market distribution centers may be combined. The market distribution center enables sufficient scale to afford automated decanting, as well as limits the cost of transporting eaches in totes and subtotes to a localized, for example metropolitan area. The more efficient shipping of eaches in densely pack cases on pallets can be maintained between the regional distribution center and the market distribution center. The market distribution center further offers the capability to store a large selection of goods that a customer may order to be delivered to their market on the next rapid replenishment delivery, that is not regularly stored at the market.

Referring to U.S. Patent Publication No. US2018/0341908 (“the '908 Reference”), FIGS. 1 and 2 show a portion of an automated self-service retail store 100. The store 100 includes a shopper-accessible area 102 including multiple aisles 104 having totes 106 from which a shopper 110 can select eaches for placement in her shopping cart. The aisles 104 may include flat panel monitors 112 describing the eaches within a tote 106. The flat panel monitors may be other input terminals, such as displays, or interactive touchscreens, providing the price and information about items in the totes beneath them.

The store 100 may further include an item storage and replenishment area 122 positioned above the shopper-accessible area 102. The item storage and replenishment area 122 stores totes 106 in storage racks 128 for replenishing totes 106 in the shopper-accessible area 102. The storage racks are in turn connected to rails along which the mobile robots 124 travel. The totes 106 are automatically delivered by mobile robots 124 to the shopper-accessible area 102, for example when a tote in shopper-accessible area 102 is empty. At the same time, the item information above the tote is updated on the flat panel monitor. The robot 124 may replenish an empty tote 106 with the same or a different item. A central Material Control System (MCS) 114 controls the mobile robots and also updates the information above the totes. The MCS 114 may control when totes 106 in the shopper-accessible area 102 are replenished and with what. The MCS may also keep track of items removed from totes 106 by a shopper 110 as explained below.

FIGS. 1 and 2 of the '908 Reference show a single shopper-accessible area 102 positioned beneath the item storage and replenishment area 122. However, in further embodiments, the item storage and replenishment area 122 may be below, or on the same level as the shopper-accessible area 102. Additionally, in further embodiments, there may be multiple levels of shopper-accessible areas 102, each replenished from totes stored in the item storage and replenishment area 122.

FIGS. 1 and of the '908 Reference show a system where inventory is maintained in totes 106 at the shopper-accessible level 102. However, in further embodiments, the shopper-accessible level 102 may not store inventory. Instead, the shopper-accessible level may include stations, (shopper stations) and display screens 112. In this embodiment, the shopper can select their desired items from the display screen, and totes containing those items are brought to the user by mobile robots 124. Once a shopper picks their desired item from a tote 106, the tote 106 may be carried away by the mobile robot 124, and additional totes brought to the shopper 110 with their selected items. The shopper's selected items may be brought to the user in totes carried by several different robots, whose movements are coordinated by the MCS 114.

Referring to U.S. patent application Ser. No. 17/236,082 (“the '082 Reference”) (claiming priority to U.S. Provisional Patent Application 63/013,504), FIG. 11 shows atop view of exemplary system 250 that utilizes width wise insertion and extraction from a storage structure and both width wise and length wise insertion and extraction from shipping truck boxes. System 250 has storage structure 256, dock staging area 258 and trucks 260, 262. Storage structure 256 has racks 264 that may have rails and verticals to allow Bots 150 to traverse along the aisles on the support rails or from aisle to aisle vertically (level to level). Storage structure 256 has transit decks 266 that allow Bots to move horizontally from aisle to aisle. Collapsible rack 100 (FIGS. 1-2 of the '082 Reference) is shown being removed from or inserted into rack structure 264 widthwise in FIG. 11 of the '082 Reference. Alternately, collapsible rack 100 may be made up of two racks or more racks where they are combined in a single collapsible rack with more than two tote supporting structures that collapse as shown. Collapsible rack 100 is shown being removed from or inserted into truck 260 widthwise and truck 262 lengthwise. Alternately, a combination of lengthwise and widthwise racks may be provided in a collapsible, collapsed or open/un-collapsed configuration. An automated motorized robot (AMR) 206 may be utilized to transport racks 100 to and from the storage structure where automated motorized robot (AMR) 206 may be an automated robot that acts autonomously. Alternately, automated motorized robot (AMR) 206 may be a human operated power assisted transport drive, and automated guided vehicle, automated fork truck or other suitable drive adapted to transport racks 100 from destination to destination. Alternately, racks 100 may be manually transported where no automated motorized robot (AMR) 206 would be provided. In the embodiment shown, racks 100 are collapsed and inserted into truck 260 widthwise and truck 262 lengthwise. Alternately, racks 100 may be partially collapsed, for example, where Bots 150 are intended to be transported as shown. In the embodiment shown, racks 100 may be shunted widthwise or moved linearly directly to/from the rack structure 256 and then transported lengthwise as shown or widthwise from/to trucks 262, 260.

Referring to U.S. Patent Application No. U.S. Ser. No. 16/831,468 (“the '468 Reference”), FIG. 1 shows a schematic plan view of order fulfillment system 10. Order fulfillment system 10 has multilevel tote storage and retrieval structure 20, ambient and chilled autonomous robotic vehicles or robots capable of working in ambient and chilled environments 22, 24 configured to pick, transport and place one or more tote within the order fulfillment system, ambient 26 and chilled 28 workstations configured to accommodate a picker (human, automated or otherwise) that transports one or more eaches from a tote, for example a product tote containing multiple common eaches to be picked, on one of the autonomous mobile robots to a put location, for example an order tote that has a combination of different eaches that reflects a full or partially fulfilled order, that may be on another of the autonomous mobile robots at the workstation, ambient and chilled transit decks 30, 32 configured to support, stage and buffer the autonomous robots 22, 24 between the storage and retrieval structure 20 and the workstations 26, 28, dispense station 34 where totes containing fulfilled orders are discharged from the order fulfillment apparatus and a decant or input interface (not shown) configured to replenish the apparatus. Here, the ambient static workstation(s) 26 may be co-located with ambient storage 38 and chilled static workstation 28 may be co-located with chilled storage 40. Further, ambient and/or chilled storage may occupy one or more full aisle. Tote storage and retrieval structure 20 may have ambient and chilled storage and retrieval structures 38, 40 that may be located adjacent as shown or otherwise placed, for example, the chilled storage may be located at an elevation below the ambient storage locations where frozen locations may be at a lowest level(s) in elevation and with chilled storage at the next level(s) in elevation and ambient at the next level(s) in elevation or otherwise. Alternately, the chilled and ambient storage may be arranged in any suitably appropriate way. Further, a rear mezzanine 42 may be provided for ambient and chilled storage and retrieval 38, 40 to allow a robot to be removed from the system to ambient, for example, bagged or isolated from chilled to ambient to prevent condensation on or within the robot. Alternately a hot box transition may be provided. Chilled tote storage and retrieval structure 40 may have chilled storage area 46 and frozen storage area 48 where chilled storage area and frozen storage area may be independently refrigerated and insulated, for example to 34 degrees F. and 0 degrees F. respectively. Alternately, chilled storage area 46 and frozen storage area 48 may be further segregated with different temperature levels or with temperature gradients sufficient to satisfy a broad range of chilled and frozen goods. Chilled transit deck 32 may be segregated and insulated from the ambient transit deck 30. Similarly, the interior of chilled workstation 28 may be isolated from the picker, who may be in an ambient environment picking and placing eaches from product totes to order totes in the chilled interior of the chilled workstation. Autonomous robots 22 may move freely between the chilled transit deck and ambient deck as will be described where the two are separated by insulated or and suitable door(s) or divider(s) that isolate the two areas as will be described.

The autonomous robotic vehicles or robots 22, 24 may be wholly or substantially identical and separated into specific robot types. To allow robots to place a tote near the next pick up tote location during peak periods, robots may be exposed to long durations in chilled storage or retrieval areas. As such, robots may to be segregated into A-Bots 22 and C-Bots 24 where A-Bots are Ambient Bots primarily located in ambient storage and retrieval areas and C-Bots are Chilled Bots primarily located in chilled storage and retrieval areas. An MCS (material control system) may be provided and manages A-Bot and C-Bot watermarks with soft dedications. By way of example, the MCS may be configured such that idle A-Bots may be stored in rear ambient towers of the storage and retrieval system or otherwise. Similarly, the MCS may be configured such that idle C-Bots may be stored in rear chilled towers of the storage and retrieval system or otherwise. In the embodiment shown, storage and retrieval system may accommodate three temperature zones; Ambient, Chilled, and Frozen as previously described. Similarly, totes may be identical or substantially similar but may be segregated into types, for example, to avoid condensation on products, totes may be segregated into Chilled totes and Ambient totes.

TABLE 1
A-Bot and C-Bot domains (*indicates dash moves)

| | Static WS | | | Dynamic | Static WS |
|---|---|---|---|---|---|
| Bot Type | Decant | Storage | Deck | WS | Dispense |
| A-Bot | Ambient | Ambient | Ambient | Ambient | Ambient |
| | | Chilled* | Chilled* | | |
| | | Frozen* | | | |
| C-Bot | Chilled | Chilled | Chilled | Chilled | NA |
| | | Frozen* | | | |

As noted, robots may to be segregated into A-Bots 22 and C-Bots 24 where A-Bots are Ambient Bots primarily located in ambient storage and retrieval areas and C-Bots are Chilled Bots primarily located in chilled storage and retrieval areas where “primarily” denotes where the robot spends the majority but not all of the robotic vehicles time. By way of example, A-Bots 22 may dash into frozen and chilled storage zones to retrieve order-totes for dispense. Similarly, C-Bots 24 may dash into frozen for product-tote retrieval and storage. As a further option, C-Bots 24 may deliver o-totes near a zone transition point (pass-through interlock) to limit the duration an A-Bot is in a chilled or frozen zone. Bot temperature may be monitored for Bot Transitions Between Zones (*). Here, the MCS may track and manage bots based on feedback from internal and external temperature sensors and humidity sensors on the bot. For example, the MCS may calculate dew points (DP) from bot feedback in each temperature zone. In one aspect, bot sensors may indicate critical surfaces are above dewpoint. When dewpoint is neared, the MCS may direct the bot to exit back into ambient. Here, the MCS may manage the transitions, for example, with the following exemplary rules based on such configurable attributes as minimum entrance temperature delta for dash moves (ex: +10 C), move abort temperature offset for canceling dash moves (ex: +5 C), minimum exit temperature delta for bots to enter a warmer temperature zone (ex: +2 C above DP), allowable (minimum or maximum) dwell time(s) within given zone(s) as a function of bot type or otherwise any suitable configurable attribute(s).

Condensation mitigation may be required for the robots. For example, when going from ambient to chilled no special process may be needed. However when going from chilled to ambient there may be a need to mitigate condensation by heating the bot, for example in hot box 50. Here, hot box 50 may be a hot plate, external heaters in a “garage bay” or alternately exercising motors in a tower or otherwise. Similarly, Condensation mitigation may be required for the totes. For example, when transitioning between tote types ambient to chilled then no special process may be needed. However when transitioning between tote types chilled to ambient there may be a need to mitigate condensation by allowing the tote to heat up to or close to ambient temperature, for example, by letting the tote sit for a duration before allowing use.

Referring still to U.S. Patent Application No. U.S. Ser. No. 16/831,468, FIGS. 15-20 show views of tote 850. While the term “tote” is used herein, it is understood that the tote 850 may be any of various receptacles, canisters or other containers for transporting and storing goods, including goods to be transported and stored at different temperatures as explained below. Tote 850 has tote enclosure 852, tote lid 854 and insulated interior as will be described in greater detail. Lid 854 may be hinged with hinges 856 as shown with respect to enclosure 852. In alternate aspects, lid 854 may be hinged or have no hinge. Lid 854 and enclosure 852 may be insulated such that heat losses from ambient may be minimized and condensation on the exterior may be minimized as will be described in greater detail. The insulation may be conventional, by vacuum enclosure or otherwise. By way of example, the insulation may be provided as an insulated insert to insulate a conventional plastic tote and further accept a chilled or passive liner as will be described in greater detail. RFID temperature sensors 858 may be provided on the tote. In the embodiment shown, RFID sensors 858 are shown at opposing ends of tote 850 where a Bot with an RFID reader may read the RFID sensor for tote identification and/or for other purposes, for example, for reading temperature within or outside of tote 850 where RFID sensor 858 may be a passive temperature sensor enabled by the RFID reader on the Bot. Such a passive temperature sensor may sense temperature with a thermistor or other temperature sensor connected to circuitry and the RFID antenna. Such sensors are commercially available from RFID suppliers such as Metalcraft located in Mason City, IA. In alternate aspects, one or more passive RFID tags and/or sensors may be provided, for example, for temperature, identification, humidity, moisture detection or otherwise within or external to the tote assembly. Tabs 864 are provided as part of lid 854 for the purpose of opening the lid, either by a person or in an automated fashion as will be described in greater detail. Tabs 864 may be formed of the same material as lid 854 or may alternately be rollers that interact with a cam or other active or passive mechanism to open lid 854. Although two tabs 864 are shown, more or less may be provided.

FIG. 18 of the '468 Reference shows a cross section view of tote 850. FIG. 19 of the '468 Reference shows a partial cross section view of the upper left-hand corner of tote 850 as shown in FIG. 18. Tote 850 further has insulating wall panels 870, insulating floor panel 872 and insulating lid panel 874. Insulating panels may also be provided on the two opposing ends of the tote 850 such that the contents within tote 850 are completely or substantially surrounded by insulating panels or insulation. Although panels 870, 872 are shown as separate panels, a unitary construction may be provided for insulation where separate panels need not be provided. Panels 870 are shown of a uniform thickness where in alternate embodiments the thickness may vary, for example from top to bottom. Although panels 870, 872 are shown the same thickness, panels 870, 872 may be of differing thicknesses. Similarly, panels 870, 872 and 874 may all be of differing thicknesses or the same thickness. Gasket 878 is shown bonded or fastened to the top portion of insulating panel 870 where gasket 878 substantially or completely seals the circumference of lid 854 to the insulated enclosure to prevent heat leakage when lid 854 is closed. Gasket 878 may be a refrigerator type or any suitable type of gasket made from EPDM, neoprene or other suitable material that seals against lid 854 by compression, magnetic attraction or otherwise. In the case of magnetic attraction, a metallic insert (not shown) may be provided with lid 854 that interfaces with seal or gasket 878. In alternate aspects, gasket 878 may be bonded or otherwise fastened to lid 854 and seal against panel 870. Tote 850 further comprises a thermal insert 882, also referred to herein as simply insert 882. Insert 882 has a cavity 884 within the insert 882. An insert 882 with cavity 884 is provided on and covers each of the panels 870 so that the inserts 882 and cavities 884 substantially surround an interior of the tote 850. Insert 882 is shown having floor 886 that protects panel 872 against damage, for example from eaches within the tote 850. A gap 888 (FIG. 19 of the '468 Reference) may be provided between the exterior surface(s) of insert 882 and the interior surfaces of insulating panel(s) 870, 872. This gap may be any suitable size and is provided to promote air circulation around the exterior and interior surfaces of insert 882 such that when the phase change material contained within insert 882 is regenerated, chilled air is exposed to the surfaces of insert 882 that surround the phase change material to minimize the amount of time it takes to regenerate the phase change material within insert 882. Insert 882 may be made from any suitable material, for example, aluminum, PVC or polypropylene. The cavity 884 in insert 882 may be filled with a suitable material 890 such as a phase change material to maintain a given set temperature point or range within tote 850. The phase change material may be tailored to have a phase transition temperature of 1 degree F. for a frozen storage temperature window of 0 to 5 degrees F. Similarly, the phase change material may be tailored to have a phase transition temperature of 35 degrees F. for a chilled storage temperature window of 34 to 40 degrees F. Alternately any suitable phase transition temperature and storage temperature window may be provided. In alternate aspects, insert 882 may not contain a phase change material and instead may be made in whole or in part of suitable material with sufficient thermal capacity to maintain temperature within tote 850. Insert 882 in combination with a suitable material 890 such as a phase change material has among others, features of note: 1. As the phase change material is positioned between the eaches and the insulation, thus exposing the eaches directly to the phase change material temperature, the phase transition temperature may be set equal to the setpoint temperature within the tote; 2. Provides a uniform media to maintain uniform temperature within tote 850; 3. Provides a large surface area to facilitate efficient regeneration of material 890; 4. Provides for a removeable liner or insert that is easily cleaned and disinfected; and 5. Protects the insulation, for example vacuum insulated panels 870 from damage by the contents within tote 850.

Regarding point 1 above, by putting the phase transition material at substantially all insulated panels, the eaches are only exposed to the phase transition temperature of the inserts on all such panels. Any gradient to the ambient is isolated external to the inserts (across the insulating panels). This enables the use of the phase transition temperature as the setpoint. Conventionally, heat which enters a tote across insulated panels does not hit the “phase transition” barrier, and thus the temperature of the eaches is exposed to these internal gradients. Although material 890 is shown surrounding the interior walls of tote 850, in alternate aspects material 890 may also surround or cover other areas of the interior, for example as will be described.

Referring to U.S. Patent Publication No. US2020/0039746 (“the '746 Reference”), FIG. 1 shows a plan view of an automated decant workstation 10. FIG. 2 of the '746 Reference shows a side elevation view of automated decant workstation 10. There are two positions 12, 14 where pallets 16 of cases 18 to be decanted are positioned for processing. Only one pallet may be processed at a time, which allows an empty pallet to be replaced with a full pallet while the second pallet is being processed. Pallets supply layers of cases 18 to be processed by the workstation, one SKU at a time; cases of multiple layers can be combined for processing, for example if they are the same SKU, and loading of all of the eaches from a given SKU may be completed before any eaches from a different SKU are loaded.

Pallet Lift 20 may be provided to elevate the input pallet so that the top layer of cases can be transferred onto Case-Singulation Table 22 to be processed. The singulation table feeds cases in single-file onto two conveyors 24, 26, each of which feed cases into case stripping machine 28, 30 that removes the case packaging materials from each case. Once the packaging materials have been removed, the contained eaches can then be manipulated in groups and bulk-loaded into totes and subtotes. First, the eaches move onto Accumulation Table 32, which accumulates eaches 52 of the same SKU from multiple cases. At the opposite end of the accumulation table, sets of eaches are moved one at a time onto a Load-Staging table 34. There they are separated into subtote groupings by a Load Organizer using Divider/Manipulators 36 that mirror the configuration of subtote walls. Dividers 36 may include multiple dividers that are selectively movable and positionable from the sides of the accumulated eaches where some may be moveable vertically and horizontally on a gantry from above to selectably form any suitable pattern of dividers to match the walls of the tote and/or subtotes that the eaches are to be deposited or loaded into.

The inbound bots travel to tower 70 to descend to the lower level to deposit empty totes onto a tote handler 40. Directly under the load-staging table is the tote to be loaded 38, supported by the Tote Handler 40 and precisely aligned with the load of eaches, i.e. the subtotes 54 are positioned precisely below the subtote groupings of eaches. Tote handler 40 may be any suitable vertical indexer where position and velocity can be suitably controlled. Tote handler 40 may also positively grasp the tote in the event it needs to exceed >1 g or otherwise. Once the load of eaches is organized properly, the surface 42 of the staging table 34 abruptly disappears very rapidly (far faster than 1 g), while also retracting completely into an adjacent housing 44. Here staging table may be a single table or split as shown. Further staging table 34 may be simply laterally moved very quickly, moved rapidly at a downward angle, or alternately be lowered and then or simultaneously be laterally moved out of the way. Alternately staging table 34 may be hinged horizontally or vertically or otherwise moved out of the way of the dropping eaches. Alternately a multi piece iris may be used. In the event the staging table is moved vertically or otherwise, it may further be perforated to prevent suction from the rapid separation from the eaches. Staging table 34 may be moved by actuators including pneumatic, electric or any suitable actuation.

The tote-handler 40 brings the tote to a stop between and aligned with the Inbound 48 and Outbound 50 Tote Conveyors (for example, inbound and outbound mobile robots), with transfer mechanisms interfacing those conveyors with the tote handler. If the tote is to receive another layer of eaches in a second load, it would return to the receiving position just under the staging table, and the process would be repeated. Otherwise, the filled tote is transferred onto the outbound conveyor, and an empty tote is transferred onto the tote handler, which returns to the receive position to be loaded. Because the organization of a next load of eaches overlaps in time with the drop-loading of the previous set of eaches, the load cycle can be initiated as soon as the receiving tote 38′ is in load position.

Regarding U.S. Patent Publication No. US2019/0047787 (“the 787 Reference”), FIGS. 14 and 15 illustrates a universal gripper 110 mounted to a Cartesian robot 150. The robot 150 is driven along a pair of rails 152 by a pair of motors 154 on the robot 150. For example, each rail 152 may include toothed timing belt drives, driven by one through-shaft servo motor 154. The through shaft is attached to the two parallel drives to ensure the two sides are driven uniformly.

The robot 150 further includes a shaft 158 which affixes within hub 118 of the gripper 110 to translate and/or rotate the gripper 110. FIG. 15 of the 787 Reference is a perspective view of the robot 150 and gripper 110 transferring a sub-tote 102 (such as sub-tote 102a) from one tote to another tote. The Cartesian robot and gripper may be mounted within the storage racking to enable in-storage transfers of sub-totes between the full totes. This is used to defragment the storage; i.e. combine empty sub-totes together in full totes, and thereby increase storage density within the system.

FIG. 15 of the 787 Reference shows the gripper 110 in a fully raised position. Depending on tine length, gripper does not need to be raised to full height position when not carrying a sub-tote. The figures also show a second one-sixth sub-tote 102a in the position to be transferred. The second pair of gripper tines on the opposite side penetrate through the slots in the top exterior flanges of this opposite side sub-tot. However, the second pair of tines are not driven apart thereby allowing the second pair of tines to be lifted without lifting the opposite side sub-tote. If the one-sixth, or one-half sub-totes on opposite sides of the full tote are desired to be lifted together, then all tines are driven apart to position the lifting tabs underneath the top exterior flanges of both sub-totes.

Each of the patents and patent applications discussed above are hereby incorporated by reference herein in their entirety.

The foregoing detailed description has been presented for purposes of illustration and description. It is not intended to be exhaustive or to limit the description to the precise form disclosed. Many modifications and variations are possible in light of the above teaching. The described embodiments were chosen in order to best explain the principles of the claimed system and its practical application to thereby enable others skilled in the art to best utilize the claimed system in various embodiments and with various modifications as are suited to the particular use contemplated. For example, all or any subset of products, not just picking all of NFPG products in the G2P system may be applied to picking in the G2P system.

What is claimed is:

1. A store providing goods, the store comprising:
a self-service area comprising shelves configured to buffer goods to fulfill self-service orders picked by in-store shoppers and to buffer goods to fulfill online orders, the self-service area comprising fresh order-line goods; and
an automated goods-to-person (G2P) area including an automated storage and retrieval system configured with storage areas to store goods and one or more picking stations to fulfill the online orders of goods;
wherein, in response to an online order, one or more fresh order-line goods of the fresh order-line goods are selected, a secondary operation is performed on the one or more fresh order-line goods and the fresh order-line goods are moved to a container, and
wherein the container including the one or more fresh order-line goods is moved to the G2P area to fulfill the online order.

2. The store of claim 1, further comprising a digital identifier associated with the container, the digital identifier associating the container with the online order.

3. The store of claim 1, wherein the container is stored on a storage shelf within the storage area of the G2P area while a remainder of the online order is assimilated.

4. The store of claim 3, wherein the container is transferred from the storage shelf to a picking station of the one or more picking station, the one or more fresh order-line goods transferred to an order container, along with other goods in the online order, to fulfill the online order

5. The store of claim 1, wherein the secondary operation performed on the one or more fresh order-line goods comprises placing the one or more fresh order-line goods in a bag and placing the bag in the container.

6. The store of claim 1, wherein the secondary operation performed on the one or more fresh order-line goods comprises weighing the one or more fresh order-line goods and storing the weight of the one or more fresh order-line goods in association with the online order.

7. The store of claim 1, wherein the secondary operation performed on the one or more fresh order-line goods comprises scanning a digital code on packaging of the one or more fresh order-line goods to identify information of the one or more fresh order-line goods and storing the information in association with the online order.

8. The store of claim 1, wherein the container comprises a tote and sub-tote within the tote, the one or more fresh order-line goods placed within the sub-tote of the tote and moved to the G2P area to fulfill the online order.

9. The store of claim 1, wherein the secondary operation is performed before the one or more fresh order-line goods are transferred to the G2P area.

10. A store providing goods, the store comprising:
a self-service area comprising shelves configured to buffer goods to fulfill self-service orders picked by in-store shoppers and to buffer goods to fulfill online orders, the self-service area comprising fresh order-line goods; and
an automated goods-to-person (G2P) area including an automated storage and retrieval system configured with storage areas to store goods and one or more picking stations to fulfill received orders of goods;
wherein, in response to multiple online orders, the fresh order-line goods are batch picked from the self-service area, a secondary operation is performed on the fresh order-line goods, and the fresh order-line goods are moved to sub-totes to fulfill multiple online orders, and
wherein the sub-totes are stored on storage shelves in the storage areas of the G2P area.

11. The store of claim 10, wherein each sub-tote of the sub-totes stores one or more fresh order-line goods for a separate online order.

12. The store of claim 10, wherein the batch picking of fresh order-line goods occurs during off-peak hours of the self-service area.

13. The store of claim 10, wherein the secondary operation performed on the fresh order-line goods comprises placing one or more of the fresh order-line goods in one or more bags and placing the one or more bags in the sub-totes.

14. The store of claim 10, wherein the secondary operation performed on the fresh order-line goods comprises weighing one or more of the fresh order-line goods and storing the weights of the one or more fresh order-line goods in association with one or more of the online orders.

15. The store of claim 10, wherein the secondary operation performed on the fresh order-line goods comprises scanning digital codes on packaging of one or more of the fresh order-line goods to identify information of the one or more fresh order-line goods and storing the information in association with one or more of the online orders.

16. The store of claim 10, wherein the secondary operation is performed before the fresh order-line goods are transferred to the G2P area.

17. A method of providing goods in a store, comprising:
(a) storing goods to a self-service area, the self-service area provided to buffer goods to fulfill self-service orders by in-store shoppers and to buffer goods to fulfill online orders, the self-service area comprising fresh order-line goods;
(b) storing goods to fulfill online orders in a goods to person (G2P) area, the G2P area configured with storage areas to store goods and one or more picking stations to fulfill received orders of goods;
(c) picking fresh order-line goods from the self-service area;
(d) performing a secondary operation on the fresh order-line goods picked in said step (c); and
(e) transferring goods from the self-service area to the G2P area for automated fulfillment of the online orders.

18. The method of claim 17, wherein said step (c) of picking fresh order-line goods from the self-service area comprises the step of batch picking several fresh order-line goods from the self-service area to fulfill multiple online orders.

19. The method of claim 17, wherein said step (c) of picking fresh order-line goods from the self-service area comprises the step of picking fresh order-line goods from the self-service area during off-peak hours of the store.

20. The method of claim 17, wherein said step (d) of performing a secondary operation on the fresh order-line goods comprises the step of placing the fresh order-line goods in bags and transferring the bags to the G2P area.

21. The method of claim 17, wherein said step (d) of performing a secondary operation on the fresh order-line goods comprises the step of weighing the fresh order-line goods and storing the weights of the fresh order-line goods in association with online orders.

22. The method of claim 17, wherein said step (d) of performing a secondary operation on the fresh order-line goods comprises the step of scanning digital codes on packaging of the fresh order-line goods to identify information of the fresh order-line goods and storing the information in association with the online orders.

23. The method of claim 17, wherein said step (d) of performing a secondary operation on the fresh order-line goods is performed prior to said step (e) of transferring goods from the self-service area to the G2P area.
